(19) United States
(12) Patent Application Publication
(10) Pub. No.: US 2026/0189679 A1
(43) Pub. Date: Jul. 2, 2026

(54) OPTICAL MODULE AND PROJECTOR

(71) Applicant: SEIKO EPSON CORPORATION, Tokyo (JP)

(72) Inventor: Takuo YONEYAMA, AZUMINO-SHI (JP)

(21) Appl. No.: 19/431,250

(22) Filed: Dec. 23, 2025

(30) Foreign Application Priority Data
Dec. 26, 2024 (JP) 2024-230021

(51) Int. Cl. H04N 9/31

(52) U.S. Cl. CPC H04N 9/3135; H04N 9/3164

(57) ABSTRACT

Optical module includes of the present disclosure a light source including a first light emitting section configured to emit first light having a first wavelength; a light scanning section that scans light emitted from a light source; and a light modulation section that, based on image information, modulates scanned light scanned by the light scanning section, wherein the light scanning section changes a light path length of the scanned light incident on the same position of the light modulation section to be equal to or longer than a coherence length of the first light by an optical element that rotates around a rotation axis extending along a direction intersecting an incident direction of the light.

The present application is based on, and claims priority from JP Application 2024-230021, filed December 26, 2024, the disclosure of which is hereby incorporated by reference herein in its entirety.

### BACKGROUND

### 1. Technical Field

The present disclosure relates to an optical module and a projector.

### 2. Related Art

As a light source device used in a projector, there has been proposed a light source device that illuminates a light modulation device by temporally scanning light emitted from a light emitter on the light modulation device such as a liquid crystal panel.

JP-A-2007-225956 discloses a projector including a light source device, a liquid crystal light valve, a polygon mirror provided between the light source device and the liquid crystal light valve, and a projection lens. In the projector, the polygon mirror reflects the light emitted from the light source device and scans the light in a short axis direction of an elliptical light beam cross-section on an image forming region of the liquid crystal light valve.

JP-A-2007-225956 discloses a projector including a light source device, a liquid crystal light valve, a polygon mirror provided between the light source device and the liquid crystal light valve, and a projection lens. In the projector, the polygon mirror reflects the light emitted from the light source device and scans the light in a short axis direction of an elliptical light beam cross-section on an image forming region of the liquid crystal light valve.

### SUMMARY

In order to solve the above problem, an optical module according to a first aspect includes a light source section including a first light emitter configured to emit first light having a first wavelength; a light scanning section that scans light emitted from the light source; and an image light generation section that generates image light from scanned light by the light scanning section, wherein the light scanning section changes a light path length of the scanned light incident on the same point on the image light generation section to be equal to or longer than a coherence length of the first light by an optical element that rotates around a rotation axis extending in a direction intersecting an incident direction of the light, and an optical module is provided.

A projector according to another aspect of the present disclosure includes the optical module of the above aspect and the projection optical device projecting the light emitted from the optical module.

### BRIEF DESCRIPTION OF THE DRAWINGS

FIG. 1 is a plan view illustrating a schematic configuration of a projector according to a first embodiment.

FIG. 2 is a diagram illustrating a configuration of a green light emitting section.

FIG. 3 is a diagram illustrating a configuration of a green light emitting section.

FIG. 4A illustrates the behavior of green light when the transmissive optical element rotates.

FIG. 4B is a continuation of FIG. 4A.

FIG. 4C is a continuation of FIG. 4B.

FIG. 4D is a continuation of FIG. 4C.

FIG. 4E is a continuation of FIG. 4D.

FIG. 5 is a cross-sectional view of the light modulation section.

FIG. 6 is a diagram of a state in which transmitted light of the transmissive optical element is incident on the same position of the light modulation section.

FIG. 7 is a plan view illustrating a configuration of a main part of an image module according to a second embodiment.

FIG. 8 is a diagram illustrating a state in which reflected light is incident on the same position of the light modulation section.

FIG. 9 is a plan view illustrating a configuration of a main part of an image module according to a third embodiment.

FIG. 10 is a diagram illustrating a state in which reflected light is incident on the same position of the light modulation section.

FIG. 11 is a diagram illustrating a configuration of a light scanning section according to a modification of the third embodiment.

### DESCRIPTION OF EMBODIMENTS

Hereinafter, embodiments of the present disclosure will be described with reference to the drawings.

In the following drawings, the scale of dimensions may be different depending on the components in order to make the components easy to see.

### FIRST EMBODIMENT

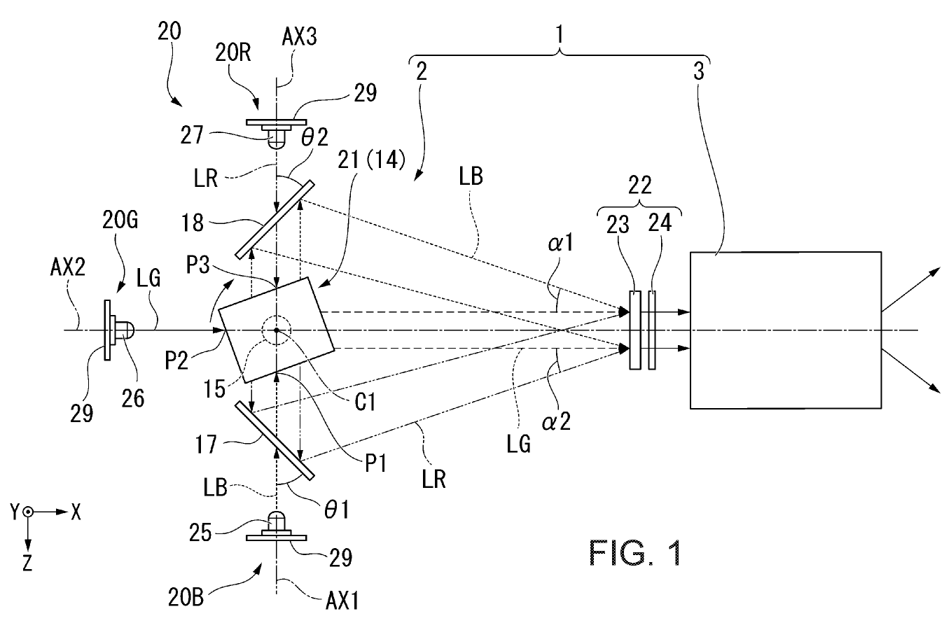

FIG. 1 is a plan view illustrating a schematic configuration of a projector according to the present embodiment.

As illustrated in FIG. 1, a projector 1 according to the present embodiment includes an image module 2 and a projection optical device 3. In the present embodiment, the image module 2 corresponds to an "optical module" of the present disclosure.

The image module 2 includes a light source 20, an optical scanning section 21, and an optical modulation section 22. The light source 20 include a blue light emitting section 20B, a green light emitting section 20G, a red light emitting section 20R, a first reflective element 17, and a second reflective element 18. The optical scanning section 21 includes a transmissive optical element 14 and a rotary drive device 15. The optical modulation section 22 includes a liquid crystal panel 23 and an emission side polarizing plate 24.

In the following description, an XYZ orthogonal coordinate system is used as necessary. The X-axis is parallel to the optical axis AX2 of the green light emitting section 20G. The optical axis AX2 of the green light emitting section 20G is defined as an axis along the principal rays of the green light LG emitted from the green light emitting section 20G. The Y-axis is orthogonal to the X-axis and extends along the rotation axis C1 of the optical scanning section 21. The Z-axis is orthogonal to the X-axis and the Y-axis, and is parallel to the optical axis AX1 of the blue light emitting section 20B and the optical axis AX3 of the red light emitting section 20R. The optical axis AX1 of the blue light emitting section 20B is defined as an axis along the principal rays of the blue light LB emitted from the blue light emitting section 20B. The optical axis AX3 of the red light emitting section 20R is defined as an axis along the principal rays of the red light LR emitted from the red light emitting section 20R.

That is, the optical axis AX1 of the blue light emitting section 20B and the optical axis AX3 of the red light emitting section 20R are located on the same axis. The optical axis AX2 of the green light emitting section 20G is orthogonal to the optical axis AX1 of the blue light emitting section 20B and the optical axis AX3 of the red light emitting section 20R.

The blue light emitting section 20B emits, for example, blue light LB having center wavelengths in the blue wavelength band of 450nm and 450nm ± 5nm. The green light emitting section 20G emits, for example, green light LG having center wavelengths in green wavelength bands of 530nm and 530nm ± 5nm. The red light emitting section 20R emits red light LR having a red wavelength band with center wavelengths of 650nm and 650 ± 5nm, for example.

The blue light emitting section 20B corresponds to a "first light emitting section" in the present disclosures, and the blue light LB corresponds to a "first light of a first wavelength" in the present disclosures. The red light emitting section 20R corresponds to a “second light emitting section" in the present disclosures, and the red light LR corresponds to “second light of a second wavelength" in the present disclosures.

The blue light emitting section 20B emits the blue light LB toward the optical scanning section 21. The green light emitting section 20G emits the green light LG toward the optical scanning section 21. The red light emitting section 20R emits red light LR toward the optical scanning section 21.

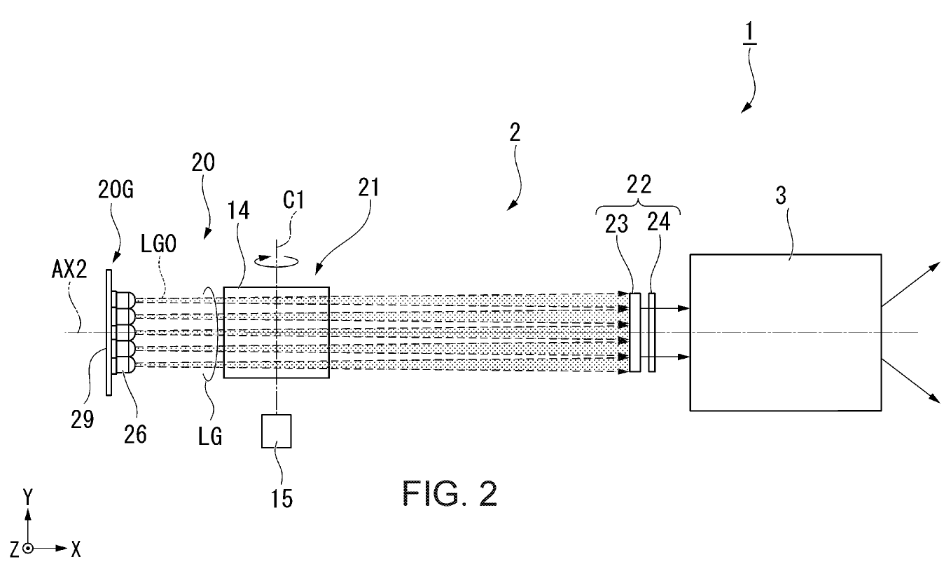

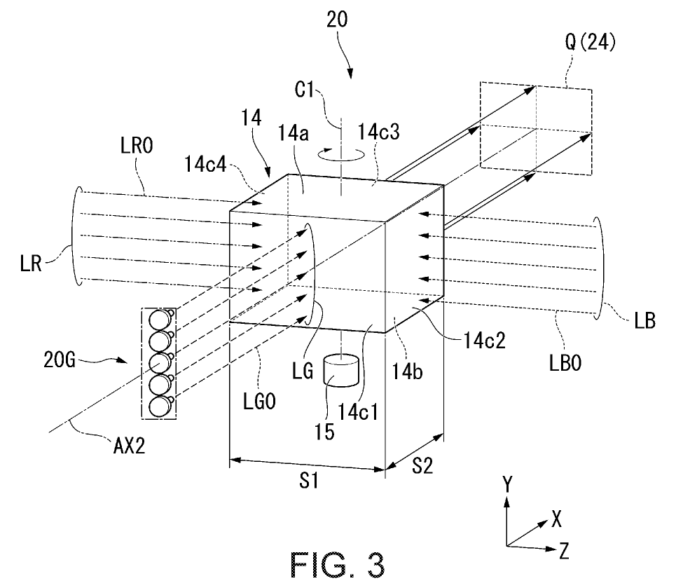

Although the basic configurations of the light emitting sections 20B, 20G and 20B are the same, since the detailed configuration of the green light emitting section 20G is illustrated in FIGS. 2 and 3, the configuration of the green light emitting section 20G will be described below as an example with reference to FIGS. 2 and 3.

As shown in FIGS. 2 and 3, the green light emitting section 20G includes a plurality of green light emitters 26 and a board 29. The green light emitters 26 are formed by laser diodes that emit light rays LG0 in the green wavelength band. Therefore, the light ray LG0 emitted from the green light emitter 26 is linearly polarized light having coherence, and is coherent light having a narrow light beam width and high parallelism.

The plurality of green light emitters 26 are arranged in a line at predetermined intervals along the Y-axis direction. In the present embodiment, the green light emitting section 20G includes five green light emitters 26, but the number of green light emitters 26 is not particularly limited, and it is sufficient that a plurality of green light emitters 26 are arranged in a line along the Y-axis direction.

In the present embodiment, the light rays LG0 are emitted from the five green light emitters 26, and the green light LG emitted from the green light emitting section 20G is therefore the entire light flux containing the five light rays LG0. Therefore, the cross-sectional shape perpendicular to the principal ray of the green light LG is a band shape having an elongated axis extending along the Y-axis direction and a short axis extending along the Z-axis direction.

The board 29 supports the plurality of green light emitters 26. Although not shown, a heat sink for cooling the plurality of green light emitters 26 may be provided on a surface of the two main surfaces of the board 29 opposite to the surface on which the plurality of green light emitters 26 are provided.

As shown in FIG. 1, the blue light emitting section 20B includes a plurality of blue light emitters 25 and the board 29. The blue light emitters 25 are formed of laser diodes that emit light ray LB0 in the blue wavelength band. Therefore, the light ray LB0 emitted from the blue light emitter 25 is linearly polarized light having coherency, and is coherent light having a narrow light beam width and high parallelism.

The plurality of blue light emitters 25 are arranged in a line at predetermined intervals along the Y-axis direction. In the present embodiment, the blue light emitting section 20B includes five blue light emitters 25, but the number of blue light emitters 25 is not particularly limited, and a plurality of blue light emitters 25 may be arranged in a line along the Y-axis direction.

The red light emitting section 20R includes a plurality of red light emitters 27 and the board 29. The red light emitters 27 are formed of laser diodes that emit light rays LR0 in the red wavelength band. Therefore, the light rays LR0 emitted from the red light emitters 27 are linearly polarized light having coherency, and are coherent light having a narrow light beam width and high parallelism.

The plurality of red light emitters 27 are arranged in a line at predetermined intervals along the Y-axis direction. In the present embodiment, the red light emitting section 20R includes five red light emitters 27, but the number of red light emitters 27 is not particularly limited, and a plurality of red light emitters 27 may be arranged in a line along the Y-axis direction.

The optical scanning section 21 scans the light emitted from the light source 20.

The transmissive optical element 14 is provided at a position where the optical axes AX1 and AX3 intersect with the optical axis AX2. The transmissive optical element 14 is made of a translucent material such as optical glass including BK7, quartz, and resins. The transmissive optical element 14 is rotatable about a rotation axis C1 extending along the Y-axis direction. The rotation axis C1 is connected to a rotary drive device 15 including a motor or the like. The transmissive optical element 14 is driven by the rotary drive device 15 to rotate about the rotation axis C1.

As illustrated in FIG. 3, the transmissive optical element 14 has a first surface 14a and a second surface 14b that intersect the rotation axis C1, and four side surfaces 14c1, 14c2, 14c3, and 14c4 that are perpendicular to and connected to the first surface 14a and the second surface 14b. That is, the transmissive optical element 14 has a shape of a quadrangular prism having six flat surfaces including the first surface 14a, the second surface 14b, and four side surfaces 14c1, 14c2, 14c3, and 14c4. Hereinafter, among the four side surfaces 14c1, 14c2, 14c3, and 14c4, the side surfaces 14c1 and 14c3 may be referred to as the first side surfaces 14c1 and 14c3, and the side surfaces 14c2 and 14c4 may be referred to as the second side surfaces 14c2 and 14c4.

The first side surfaces 14c1 and 14c3 have the same area and are two surfaces parallel to each other. The second side surfaces 14c2 and 14c4 have the same area and are two surfaces parallel to each other.

The dimension S1 of the first side surfaces 14c1 and 14c3 within a plane orthogonal to the rotation axis C1 is different from the dimension S2 of the second side surfaces 14c2 and 14c4 within a plane orthogonal to the rotation axis C1. In the present embodiment, the dimension S1 is larger than the dimension S2. That is, the cross-sectional shape of the transmissive optical element 14 taken along a plane orthogonal to the rotation axis C1 is a rectangle.

In the present specification, when two side surfaces of the transmissive optical element 14 are referred to as being parallel to each other, the case where the angle formed by the two side surfaces is in the range of 0 ± 5 degrees is referred to as "parallel" in consideration of the machining accuracy of the glass material constituting the translucent member, the allowable range of the parallelism of light, and the like.

The transmissive optical element 14, while rotating about the rotation axis C1, transmits the blue light LB, the green light LG, and the red light LR emitted from the light emitting sections 20B, 20G, and 20R, respectively. Therefore, the side surface of the transmissive optical element 14 on which the color light beams LB, LG, and LR emitted from the light emitting sections 20B, 20G, and 20R falls incident is not fixed to a single side surface, but changes with time. In the transmissive optical element 14, the side surface on which the color light beams LB, LG, and LR emitted from the light emitting sections 20B, 20G, and 20R are incident is referred to as an incident surface. The side surface from which is emitted the color light beams LB, LG, and LR that were incident on a light incident surface is referred to as a light emitting surface. In this case, the incident surface and the emitting surface change with time, and are any of two side surfaces parallel to each other among the four side surfaces 14c1, 14c2, 14c3, and 14c4. That is, in the transmissive optical element 14 of the present embodiment, the incident surface and the emitting surface are at least one of the two first side surfaces 14c1 and 14c3 and the two second side surfaces 14c2 and 14c4.

As illustrated in FIG. 1, the blue light LB is incident at a first position P1 of the transmissive optical element 14. The green light LG is incident on the transmissive optical element 14 at a second position P2, which is different from the first position P1. The red light LR enters at a third position P3, which is different from the first position P1 and the second position P2 of the transmissive optical element 14. That is, the blue light LB, the green light LG, and the red light LR are incident on different positions of the transmissive optical element 14. In particular, in the case of the present embodiment, since the light emitting sections 20B, 20G, and 20R are in a positional relationship in which they are rotated by 90 degrees about the optical axis AX1 and the intersection point of the optical axis AX3 and the optical axis AX2, the blue light LB, the green light LG, and the red light LR are incident on different side surfaces of the transmissive optical element 14.

In the case of the present embodiment, the transmissive optical element 14 has four side surfaces, but the number of side surfaces is not necessarily four, and it is preferable that the number of side surfaces be 2 ｘ m (m: a natural number equal to or greater than 2). That is, the number of side surfaces may be an even number such as six or eight. When the number of side surfaces is an even number, each of all the side surfaces is parallel to the side surface opposite to the side surface, and there is no side surface that is not parallel. This reduces the generation of stray light in the transmissive optical element 14, and can increase the light utilization efficiency.

For example, when the number of side surfaces is six, the six side surfaces include two first side surfaces parallel to each other and two second side surfaces parallel to each other. Since the dimensions of the first side surface and the second side surface are different, the cross-sectional shape of the transmissive optical element is a deformed hexagon rather than a regular hexagon. It should be noted that the hexagonal shape needs to be set to a deformation amount to the extent that light incident from one of two side surfaces facing each other is emitted from the other side surface.

The transmissive optical element 14 may be made of quartz. In the transmissive optical element 14, as the amount of light transmitted through the translucent member increases, the amount of light absorbed by the translucent member also increases, and thermal strain may occur in the translucent member. In this case, the polarization directions of the color beams LB, LG, and LR emitted from the light emitting sections 20B, 20G, and 20R are disturbed, and the linearly polarized light incident on the light translucent member becomes elliptically polarized light before being emitted from the translucent member. As a result, in the projector 1, the potential effect of using laser diodes as the light emitter to obtain a predetermined contrast without providing incident side polarizing plate is not obtained. That is, although laser diodes are used as the light emitters, it is necessary to use incident side polarizing plates for aligning the polarization directions. Therefore, in order to obtain the above effect, it is desirable to use a glass material having a large young's modulus and a small coefficient of thermal expansion as a glass material having a small thermal strain, and it is desirable to use quartz as an example.

Hereinafter, the behavior of the color light beams LB, LG, and LR when passing through the transmissive optical element 14 will be described. It should be noted that the color light beams LB, LG, and LR are incident on and emitted from the dichroic prism PS in different directions but behave in the same manner. Therefore, the green light LG emitted from the green light emitting section 20G is used for description.

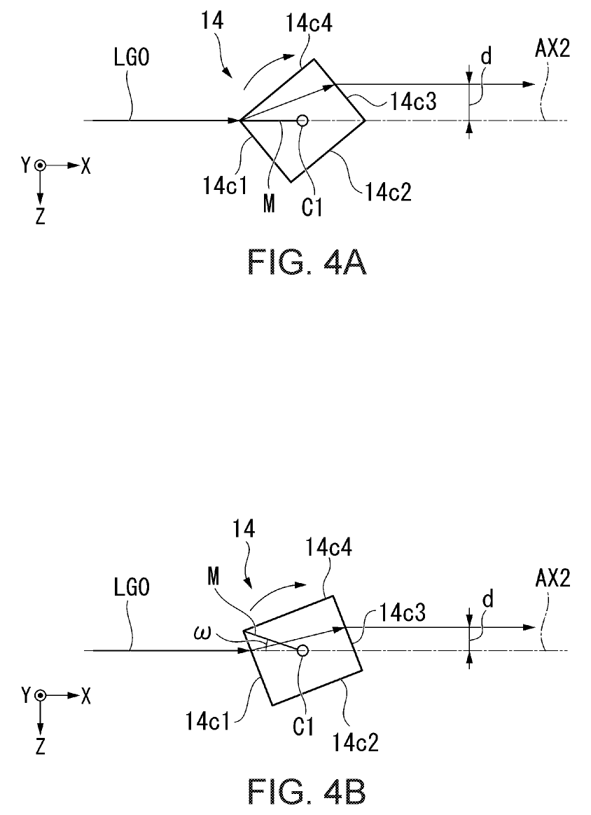

FIGS. 4A to 4E are schematic diagrams illustrating the behavior of the green light LG when the transmissive optical element 14 rotates. In this example, the transmissive optical element 14 rotates clockwise about the rotation axis C1 as viewed from the +Y side, and states while time elapses from FIGS. 4A to 4E are illustrated.

In FIGS. 4A to 4E, an angle formed between the optical axis AX2 and a straight line M, which passes through the rotation axis C1 and connects an intersection point of the side surfaces 14c1 and 14C4 of the transmissive optical element 14 and the rotation axis C1, is defined as a rotation angle ω of the transmissive optical element 14. Although in practice, the green light LG has a predetermined light beam width in the Z-axis direction, the behavior of the light ray LG0 traveling on the optical axis AX2 will be focused on.

In FIG. 4A, the rotation angle ω of the transmissive optical element 14 is 0 degrees, and the light ray LG0 is incident on the end section on the connection side between the side surface 14c1 and the side surface 14ce 14c4.

At this time, the light ray LG0 is refracted in the direction illustrated in the FIGURE(-Z side) and travels inside the transmissive optical element 14. Next, the light ray LG0 is also incident on the side surface 14c3 at a predetermined incident angle, and is therefore refracted by the side surface 14c3 and emitted from the transmissive optical element 14. At this time, since the side surfaces 14c1 and 14c3 are parallel to each other, the incident angle of the light ray LG0 is the same with respect to both surfaces, and the refraction angle of the light ray LG0 incident on the side surface 14c1 and emitted from the side surface 14c3 have equal absolute values with signs in opposite directions. By this, the refraction angle of the light ray LG0 at the time of incidence on the side surface 14c1 and the refraction angle of the light ray LG0 at the time of emission from the side surface 14c3 cancel each other. As a result, the light ray LG0 travels in parallel to the optical axis AX2 at a position displaced from the optical axis AX2 toward the -Z side by the displacement amount d. It should be noted that when the rotation angle ω is 0 degrees, the displacement amount d of the light ray LG0 toward the -Z side is maximized.

Next, as illustrated in the FIG. 4B, when the rotation angle ω of the transmissive optical element 14 becomes larger than that in FIG. 4A, the incident angle of the light ray LG0 becomes smaller, and the refraction angle becomes smaller. Therefore, the displacement amount d of the light ray LG0 from the optical axis AX2 is smaller than that in FIG. 4A. The state in which the light ray LG0 travels parallel to the optical axis AX2 is always maintained. While the rotation angle ω is in a range from 0 degrees to the state illustrated in FIG. 4C, the displacement amount d monotonously decreases with an increase in the rotation angle ω.

Next, as illustrated in FIG. 4C, when the rotation angle ω of the transmissive optical element 14 becomes approximately 45 degrees, the light ray LG0 is incident perpendicularly to the side surface 14c1, and therefore travels inside the transmissive optical element 14 along the optical axis AX2 without being refracted by the side surface 14c1. The light ray LG0 is also incident perpendicularly on the side surface 14c1 parallel to the side surface 14c3. Therefore, the light ray LG0 is emitted from the transmissive optical element 144 without being refracted by the side surface 14c3, and travels on the optical axis AX2.

Next, as illustrated in FIG. 4D, when the transmissive optical element 14 rotates by the rotation angle ω, the light ray LG0 is refracted in the direction illustrated in the FIGURE(+Z side) and travels inside the transmissive optical element 14. By this, the light ray LG0 travels in parallel to the optical axis AX2 at a position displaced from the optical axis AX2 toward the +Z side by the displacement amount d.

Next, as illustrated in FIG. 4E, when the rotation angle ω of the transmissive optical element 14 becomes larger than that in FIG. 4D, the incident angle of the light ray LG0 becomes larger, and the refraction angle becomes larger. Therefore, the displacement amount d of the light ray LG0 from the optical axis AX2 is larger than that in the case of the light ray in FIG. 4D. As described above, when the rotation angle ω is between 45 degrees and 90 degrees, the displacement amount d to the +Z side monotonously increases with an increase in the rotation angle ω. It should be noted that in the state where the rotation angle ω is as in FIG. 4E, the displacement amount d of the light ray LG0 to the +Z side is maximized.

As described above, since the incident surface and the emitting surface of the transmissive optical element 14 of the present embodiment are parallel to each other, the traveling direction of the light ray LG0 does not change regardless of the rotation angle ω of the transmissive optical element 14, and the light ray LG0 moves in parallel to the direction parallel to the optical axis AX2 with the lapse of time. The light ray LG0 repeats the above behavior also on the other side surfaces 14c2, 14c3, 14c4. Therefore, when the transmissive optical element 14 makes one rotation, the displacement amount d of the light ray LG0 repeats the above cycle four times. The displacement amount of the light ray LG0 can be appropriately set by adjusting parameters such as the refractive index and size of the transmissive optical element 14.

Although the behavior of light was described above with focus only on the light ray LG0 traveling along the optical axis AX2, as illustrated in FIG. 3, the green light LG actually extends linearly long in the Y-axis direction orthogonal to the Z-axis direction in which the green light LG is displaced. The green light LG therefore scans the two dimensional illumination region Q on the optical modulation section 22, which is the illumination target surface. The blue light LB and the red light LR have emission directions different from that of the green light LG, but are reflected by the respective reflective elements 17, 18 (to be described later), and then scan the inside of the two dimensional illumination region Q on the optical modulation section 22 similarly to the green light LG. As described above, the optical scanning section 21 can scan the blue light LB, the green light LG, and the red light LR in the two dimensional illumination target region Q on the illumination target surface by rotating the transmissive optical element 14 about the rotation axis C1 to scan the blue light LB, the green light LG, and the red light LR in the direction orthogonal to the Y-axis direction.

As illustrated in FIG. 1, the first reflective element 17 is provided in the optical path of the blue light LB emitted from the blue light emitting section 20B between the blue light emitting section 20B and the transmissive optical element 14. The first reflective element 17 is formed of a dichroic mirror that reflects red light and transmits blue light. The first reflective element 17 therefore reflects the red light LR emitted from the transmissive optical element 14 and transmits the blue light LB emitted from the blue light emitting section 20B. The angle formed by the first reflective element 17 and the Z-axis is referred to as the inclination angle θ1 of the first reflective element 17. The inclination angle θ1 of the first reflective element 17 is greater than 45 degrees.

The second reflective element 18 is provided in the optical path of the red light LR emitted from the red light emitting section 20R between the red light emitting section 20R and the transmissive optical element 14. The second reflective element 18 is formed of a dichroic mirror that reflects blue light and transmits red light. The second reflective element 18 therefore reflects the blue light LB emitted from the transmissive optical element 14 and transmits the red light LR emitted from the red light emitting section 20R. The angle formed by the second reflective element 18 and the Z-axis is referred to as the inclination angle θ2 of the second reflective element 18. The inclination angle θ2 of the second reflective element 18 is greater than 45 degrees.

Since the inclination angle θ2 of the second reflective element 18 is set to be greater than 45 degrees, the blue light LB reflected off the second reflective element 18 travels obliquely with respect to the optical axis AX2 toward the optical axis AX2. Similarly, since the inclination angle θ1 of the first reflective element 17 is set to be greater than 45 degrees, the red light LR reflected off the first reflective element 17 travels obliquely with respect to the optical axis AX2 so as to approach the optical axis AX2.

The blue light LB reflected off the second reflective element 18, the green light LG emitted from the transmissive optical element 14, and the red light LR reflected off the first reflective element 17 are incident on the first microlens array 43, which is the preceding stage of the optical modulation section 22, in different directions and overlap one another on the first microlens array 43, as will be described later. In the present embodiment, the green light LG is incident on the first microlens array 43 at an incident angle of 0 degrees. In other words, the green light LG is perpendicularly incident on the first microlens array 43. The blue light LB is incident on the first microlens array 43 at an incident angle α1. The incident angle of the red light LR with respect to the first microlens array 43 is α2.

The optical modulation section 22 is provided along the light emission side of the light source 20 along the optical axis AX2. The optical modulation section 22 modulates each of the blue light LB, the green light LG, and the red light LR emitted from the light source 20 in accordance with image information to form image light. A transmissive liquid crystal panel 23 is used as the optical modulation section 22. The liquid crystal panel does not include a color filter. As a drive system of the liquid crystal panel, a twisted nematic (TN) method, a vertical alignment (VA) method, an in-plane switching (IPS) method, or the like can be used, and the drive system is not particularly limited.

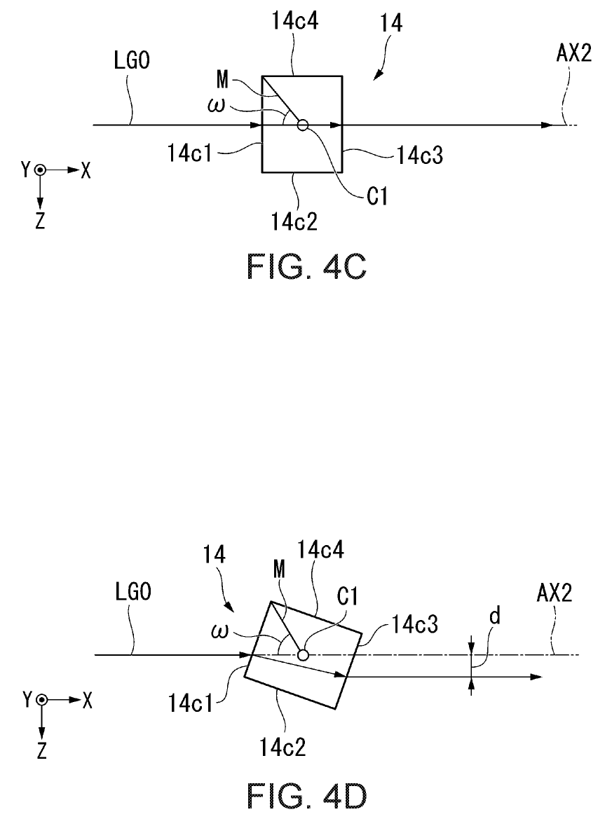

FIG. 5 is a cross-sectional view of the optical modulation section 22.

As illustrated in FIG. 5, the liquid crystal panel 23 constituting the optical modulation section 22 has a light modulation region in which a plurality of blue sub-pixels PX1, a plurality of green sub-pixels PX2, and a plurality of red sub-pixels PX3 are periodically arranged in a matrix. The blue sub-pixel PX1 modulates the blue light LB. The green sub-pixel PX2 modulates the green light LG. The red sub-pixel PX3 modulates the red light LR. One pixel, which is the smallest unit of an image, includes one blue sub-pixel PX1, one green sub-pixel PX2, and one red sub-pixel PX3. A light shielding film 55 called a black matrix is provided between two adjacent sub-pixels.

The first microlens array 43 is provided on the light incident side of the first board 57 constituting the liquid crystal panel 23. The first microlens array 43 has a configuration in which a plurality of first microlenses 431 are arranged in a matrix. The first microlens array 43 collects the blue, green, and red light and guides the collected light to the sub-pixels PX1, PX2, and PX3 of the optical modulation section 22. One first microlens 431 is formed of a lenticular lens, and is disposed over one pixel, that is, three sub-pixels PX1, PX2, and PX3 of different colors arranged in one direction. In the present embodiment, a lenticular lens is used as the first microlens 431, but the first microlens is not limited thereto, and a microlens in which square lenses are arranged in a brick-like pattern, a microlens in which lenses are arranged so as to correspond to sub-pixels in a delta array, a microlens array having a honeycomb structure, or the like may be adopted.

As described above, the blue light LB, the green light LG, and the red light LR is incident on the first microlens 431 at different incident angles, and therefore travel in different directions and is collected. By this, the blue light LB is incident on the blue sub-pixel PX1, the green light LG is incident on the green sub-pixel PX2, and the red light LR is incident on the red sub-pixel PX3. That is, the first microlens array 43 causes the blue light LB emitted from the second reflective element to be incident on the blue sub-pixel PX1, causes the green light LG emitted from the transmissive optical element to be incident on the green sub-pixel PX2, and causes the red light LR emitted from the first reflective element to be incident on the red sub-pixel PX3.

A second microlens array 44 is provided on the light emitting side of the second board 58 constituting the liquid crystal panel 23. The second microlens array 44 has a configuration in which a plurality of second microlenses 441 are arranged in a matrix. The second microlens array 44 parallelizes the color light emitted from the liquid crystal panel 23. The second microlens 441 is provided for each sub-pixel. It should be noted that although in the present embodiment, there is cited the example in which the parallelization of the respective color light beams is performed after the respective color light beams are emitted from the liquid crystal panel 23, instead of this configuration, it is also possible to dispose the second microlens array 44 on the light incident side of the liquid crystal panel 23 and perform the parallelization of the respective color light beams before the respective color light beams enter the liquid crystal panel 23.

As illustrated in FIG.1, the emission side polarizing plate 24 is provided between the optical modulation section 22 and the projection optical device 3 along the optical axis AX2. The emission side polarizing plate 24 transmits the linearly polarized light having a specific direction and emitted from the optical modulation section 22 toward the projection optical device 3. In the case of the present embodiment, since a laser diode is used for each light emitter, linearly polarized light is emitted from the light source 20. Therefore, the incident side polarizing plate provided on the light incident side of the optical modulation section 22 is not necessary. The incident side polarizing plate may be provided to improve contrast.

The projection optical device 3 is formed of a plurality of lenses. The projection optical device 3 enlarges and projects the image light modulated by the optical modulation section 22 toward a projected surface such as a screen. By this, an image is displayed on the projected surface.

In the image module 2 of the present embodiment, the cross-sectional shape of the transmissive optical element 14 is rectangular as described above, and the dimensions of the first side surfaces 14c1 and 14c3 and the second side surfaces 14c2 and 14c4 are different from each other. Hereinafter, the operation resulting from the rectangular cross-sectional shape of the transmissive optical element 14 will be described.

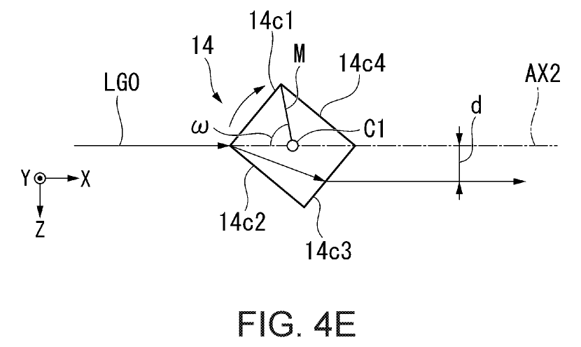

FIG. 6 is a diagram illustrating a state in which light beams transmitted through different side surfaces of the transmissive optical element 14 are incident on the same position of the optical modulation section 22. To be specific, FIG. 6 is a diagram comparing a state in which the light ray LG0 enters from the first side surface 14c1, is emitted from the first side surface 14c3, and is incident on a predetermined position 22P of the optical modulation section 22, with a state in which the light ray LG0 enters from the second side surface 14c2, is emitted from the second side surface 14c4, and is incident on a predetermined position P of the optical modulation section 22. That is, the fact that the light ray LG0 is incident on the same position of the optical modulation section 22 in the two states means that the displacement amount d of the light ray LG0 is equal when emitted from the first side surface 14c3 or the second side surface 14c4.

As illustrated in FIG. 6, the rotation state of the transmissive optical element 14 in the case where the light ray LG0 is incident on the predetermined position P of the optical modulation section 22 via the first side surfaces 14c1 and 14c3 is different from the rotation state of the transmissive optical element 14 in the case where the light ray LG0 is incident on the predetermined position P of the optical modulation section 22 via the second side surfaces 14c2 and 14c4. This is because the cross-sectional shape of the transmissive optical element 14 is not a square but a rectangle.

Therefore, when the rotational state of the transmissive optical element 14 is different, the incident angle of the light ray LG0 with respect to the transmissive optical element 14 is different, and the optical path of the light ray LG0 passing through the inside of the transmissive optical element 14 is different. That is, according to the transmissive optical element 14 of the present embodiment, the light path lengths of the green light LG incident on the same position of the optical modulation section 22 can be made different from each other. It should be noted that the amount of change in the light path length of the green light LG incident on the same position of the optical modulation section 22 can be adjusted by, for example, the refractive index, the size, or the like of the transmissive optical element 14.

The green light LG, which is coherent light, has high coherence, and thus may be visually recognized as speckle noise. The present inventor has focused on the fact that, by utilizing the characteristic of the coherence length where interference fringes cease to be visible depending on the spectral width, even laser light emitted from the same light emitter does not generate interference fringes by being synthesized with a distance equal to or longer than the coherence length. The inventor of the present disclosure has completed the configuration of the projector 1 according to the present embodiment.

In the image module 2 according to the present embodiment, by providing the transmissive optical element 14 of the optical scanning section 21 with a rectangular cross-sectional shape, the light path length of the light ray LG0 incident on the same position of the optical modulation section 22 can be changed to be equal to or longer than the coherence length of the green light LG.

The coherence length Lh is defined by the equation Lh = λ2/Δλ. It should be noted that the λ corresponds to a center wavelength, and Δλ corresponds to a wavelength bandwidth. For example, for a center wavelength of 632.8 nm and a wavelength bandwidth of 5 nm, the coherence length is about 80 μm.

As described above, according to the image module 2 of the present embodiment, since the light path length of the green light LG incident on the same coordinate of the optical modulation section 22 changes with time, it is possible to superimpose the light beams having the light path length equal to or longer than the coherence length at the same position of the optical modulation section 22. The projector 1 according to the present embodiment can therefore suppress the occurrence of interference fringes of the green light LG incident on the respective positions of the optical modulation section 22.

In the image module 2 of the present embodiment, the blue light LB and the red light LR behave in the same manner as the green light LG. In the case of the present embodiment, the three colors of light LB, LG, and LR are incident on the transmissive optical element 14. As can be seen from the above equation, the coherence length increases in accordance with the center wavelength of the incident light. That is, if a light path difference equal to or larger than the coherence length can be generated for the red light LR, it means that both the blue light LB and the green light LG are in a state of having a light path difference equal to or larger than the coherence length.

In the image module 2 according to the present embodiment, the amount of change in the light path length of the scanned light formed of the color light LB, LG, and LR with which the optical modulation section 22 is scanned by the optical scanning section 21 is changed to be equal to or larger than the coherence length of the red light LR having the longest center wavelength among the light fluxes incident on the transmissive optical element 14.

According to the image module 2 of the embodiment, it is possible to suppress the occurrence of interference fringes of the respective color light beams LB, LG, and LR for scanning the optical modulation section 22. This makes it possible to suppress speckle in the image light generated by the image module 2.

The projector 1 according to the present embodiment includes the image module 2 described above and the projection optical device 3, which projects image light emitted from the image module 2 and reduced in speckle. Therefore, according to the projector 1 of the present embodiment, since the image light with speckle suppressed is projected on the screen, it is possible to project a high-quality image with speckle noise suppressed.

### SECOND EMBODIMENT

Next, an image module according to a second embodiment will be described. The image module of the present embodiment is different from that of the first embodiment in that a reflective optical element is used as the optical element of the light scanning section. The configuration of the light scanning section will be mainly described below. The same reference symbols are given to the same configurations as those of the first embodiment, and the description thereof will not be repeated.

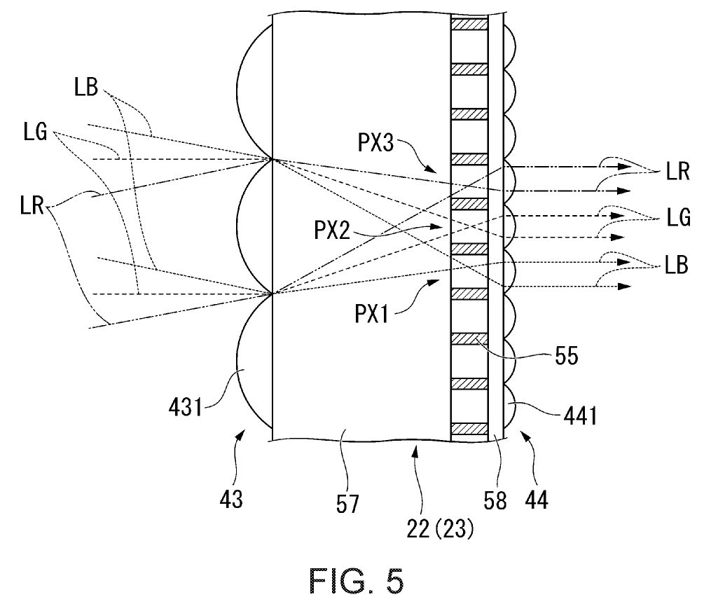

FIG. 7 is a plan view illustrating the configuration of the main part of the image module of the present embodiment.

As illustrated in FIG. 7, the image module 102 in the present embodiment includes a light source 120 that emits light L formed of laser light, a light scanning section 121, and a light modulation section 122. The light scanning section 121 according to the present embodiment includes a reflective optical element 114, a rotary drive device 15, and a rotation fixing section 16. The reflective optical element 114 reflects the light L incident from the light source 120. The light source 120 in the present embodiment emits, for example, monochromatic light L. The rotation fixing section 16 fixes the reflective optical element 114 to the rotary drive device 15 so as to be rotatable about the rotation axis C1.

It should be noted that the light modulation section 122 in the present embodiment does not employ the configuration of the optical modulation section 22 in the first embodiment in which three colors of light are incident on the sub-pixels of the liquid crystal panel 23 in three directions, and therefore includes a general liquid crystal panel that does not include the first microlens array 43 or the second microlens array 44.

The central axis 114C passing through the centers of the reflective optical element 114 is offset from the rotation axis C1 passing through the centers of the rotation fixing section 16. In other words, the reflective optical element 114 is eccentric with respect to the rotation axis C1.

The reflective optical element 114 has a first surface 114a and a second surface 114b that intersect the rotation axis C1, and six side surfaces 114c1, 114c2, 114c3, 114c4, 114c5, and 114c6 that are perpendicular to and connected to the first surface 114a and the second surface 114b. That is, the shape of the reflective optical element 114 is a regular hexagonal column having eight flat surfaces including a first surface 114a, a second surface 114b, and six side surfaces 114c1, 114c2, 114c3, 114c4, 114c5, and 114c6.

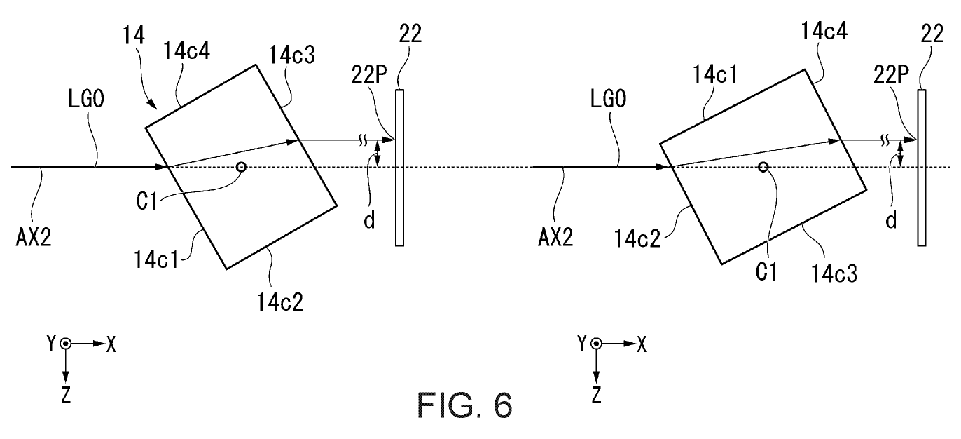

When two states are compared as illustrated in FIG. 8, the positions of the side surface 114c1 and the side surface 114c2 are different in the direction along the optical axis of the light L. This is because the reflective optical element 114 is eccentric with respect to the rotation axis C1.

In this way, the light path lengths of the light L reflected by the side surface 114c1 and by the side surface 114c2 while at different positions in the direction along the optical axis are different. That is, according to the light scanning section 121 of the present embodiment, it is possible to make the light path lengths of the light beams incident on the same position of the light modulation section 122 different from each other. The amount of change in the light path length of the light incident on the same position of the light modulation section 122 can be adjusted by, for example, the size of the reflective optical element 114.

As described above, according to the image module 102 of the present embodiment, by making the reflective optical element 114 eccentric with respect to the rotation axis C1, the positions of the side surfaces that reflect the light L incident on the same coordinates of the light modulation section 122 can be made different in the direction along the optical axis of the light L. By this, the light path length of the light L incident on the same coordinates of the light modulation section 122 can be changed to be equal to or longer than the coherence length, and the light beams having the light path length equal to or longer than the coherence length can be superimposed on each other at the same position of the light modulation section 122. Therefore, according to the image module 102 of the present embodiment, it is possible to suppress speckle in the image light by suppressing the occurrence of interference fringes of the light L incident on each position of the light modulation section 122.

Therefore, according to the projector using the image module 102 of the present embodiment, since the image light in which speckle is suppressed is projected on the screen, it is possible to project a high-quality image in which speckle noise is suppressed.

In the image module 102 of the present embodiment, the light scanning section 121 may scan the light modulation section 122 with two different color light beams. In this case, speckle noise of the two color light beams can be suppressed by generating a light path difference equal to or larger than the coherence length of the light beam that, among the two color light beams, has a long wavelength.

By combining three image modules 102 according to the present embodiment, the image modules may be applied to a three panel type projector as in the first embodiment.

In the present embodiment, the cross-sectional shape of the reflective optical element 114 is not limited to a regular hexagon as long as the reflective optical element 114 is eccentric with respect to the rotation axis C1. The shape of the reflective optical element may be, for example, an even-numbered polygon such as a square, or a rectangle as in the first embodiment. However, it is most desirable that the cross-sectional shape of the reflective optical element 114 is a regular hexagon as in the present embodiment. The first reason is that, as in the case of the square shape, the side surfaces facing each other are parallel to each other, and thus, the workability is excellent, and the light utilization efficiency can be increased by suppressing the generation of stray light. The second reason is that the amount of reflected light returning to the light source 120 side can be reduced as compared with the case of a square shape. Since reflected light returning to the light source 120 side becomes stray light, it is necessary to turn off the light source 120 during a period in which the reflected light would return to the light source 120, and the use efficiency of the light of the light source 120 is reduced. When the shape is a regular hexagon, the turn-off time of the light source 120 can be shortened as compared with the case of a square, and the light utilization efficiency of the light source 120 can be improved. The third reason is that, as the number of side surfaces of the reflective optical element increases, the light incident from the light source straddles the vertex of the optical element, and thus the reflection component toward the light source increases. That is, when the cross-sectional shape is a regular octagon or a regular decagon having a larger number of side surfaces than a regular hexagon, the light beam width of the light emitted from the light source is reduced, and thus, there is a concern that the optical axis alignment may become complicated. An optical component for expanding the light beam width of the light emitted from the light source may be additionally required. In contrast, when the cross-sectional shape is a regular hexagon, such problems as complication of optical axis alignment and necessity of additional components are less likely to occur.

### THIRD EMBODIMENT

Next, an image module according to a third embodiment will be described. The present embodiment is different from the second embodiment in the configuration of the light scanning section. The configuration of the light scanning section will be mainly described below. The same reference symbols are given to the same configurations as those of the second embodiment, and the description thereof will not be repeated.

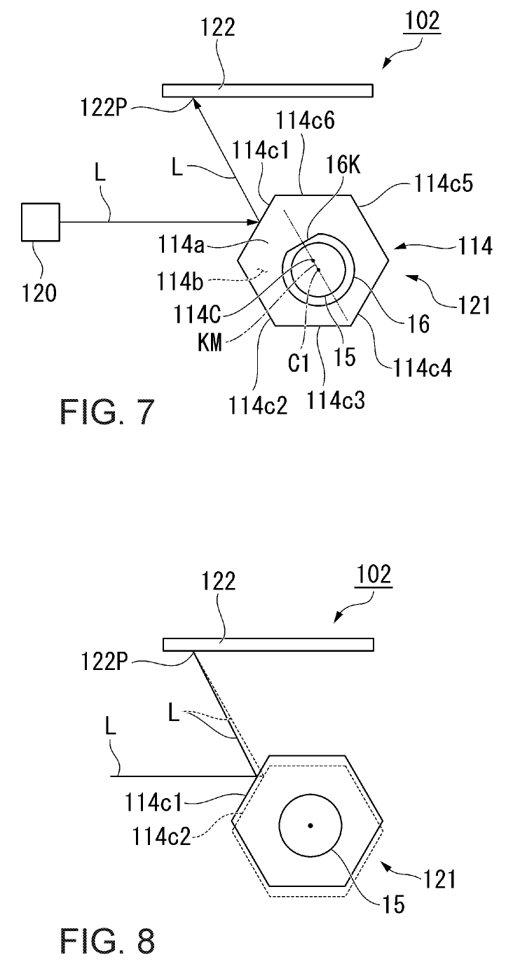

FIG. 9 is a plan view illustrating the configuration of a main part of the image module of the present embodiment.

As illustrated in FIG. 9, the image module 202 of the present embodiment includes a light source 120 that emits light L formed of laser light, a optical scanning section 221, and a light modulation section 122. The optical scanning section 221 according to the present embodiment includes a reflective optical element 214 and a rotary drive device 15. The reflective optical element 214 reflects the light L incident from the light source 120.

In the present embodiment, the central axis 214C of the reflective optical element 214 coincides with the rotation axis C1 of the rotary drive device 15. That is, the reflective optical element 214 of the present embodiment is different from that of the second embodiment in that it is not eccentric with respect to the rotation axis C1.

The reflective optical element 214 has a first surface 214a and a second surface 214b that intersect the rotation axis C1, and six side surfaces 214c1, 214c2, 214c3, 214c4, 214c5, and 214c6 that are perpendicular to and connected to the first surface 214a and the second surface 214b. That is, the shape of the reflective optical element 214 is a hexagonal column having eight flat surfaces including a first surface 214a, a second surface 214b, and six side surfaces 214c1, 214c2, 214c3, 214c4, 214c5 and 214c6. Hereinafter, among the six side surfaces 214c1, 214c2, 214c3, 214c4, 214c5, and 214c6, the side surfaces 214c1 and 214c4 may be referred to as third side surfaces 214c1 and 214c4, the side surfaces 214c2 and 214c5 may be referred to as fourth side surfaces 214c2 and 214c5, and the side surfaces 214c3 and 214c6 may be referred to as fifth side surfaces 214c3 and 214c6.

The third side surfaces 214c1 and 214c4 are two surfaces that have the same area and are parallel to each other. The fourth side surfaces 214c2 and 214c5 have the same area and are two surfaces parallel to each other. The fifth side surfaces 214c3 and 214c6 have the same area and are two surfaces parallel to each other.

The dimension S3 of the third side surfaces 214c1 and 214c4 within a plane orthogonal to the rotation axis C1 is different from the dimension S4 of the fourth side surfaces 214c2 and 214c5 within a plane orthogonal to the rotation axis C1. The dimension of the fifth side surfaces 214c3 and 214c6 are equal to the dimension S3 of the third side surfaces 214c1 and 214c4. In the present embodiment, the dimension S4 is larger than the dimension S3.

In other words, the cross-sectional shape of the reflective optical element 214 taken along a plane perpendicular to the rotation axis C1 is a deformed hexagon in which one pair of sides amongst the six sides is elongated.

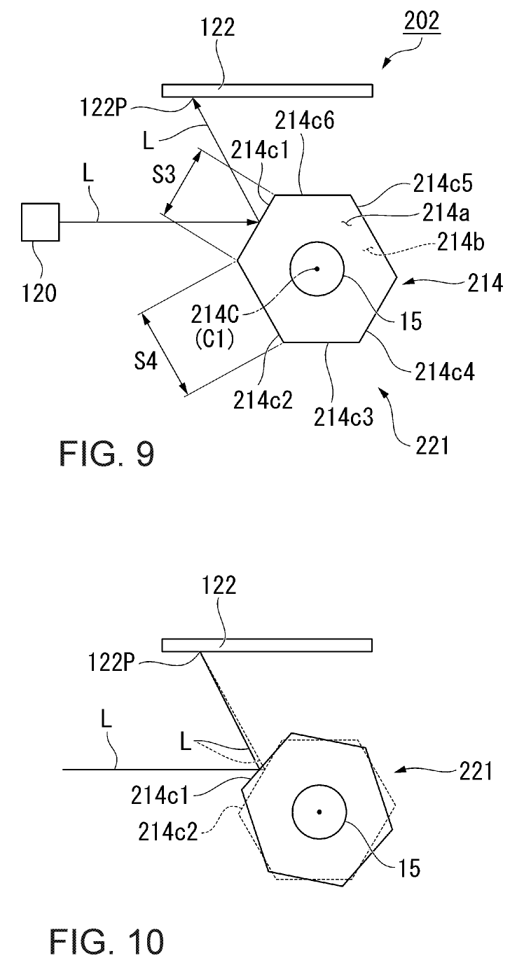

FIG. 10 is a diagram illustrating a state in which light reflected by the reflective optical element 214 is incident on the same position of the light modulation section. FIG. 10 illustrates, for example, a state in which the light L reflected off the third side surface 214c1 is incident on a predetermined position 122P of the light modulation section 122 and a state in which the light L reflected off the fourth side surface 214c2 is incident on the predetermined position 122P of the light modulation section 122.

As illustrated in FIG. 10, when the two states are compared, the positions of the third side surface 214c1 and the fourth side surface 214c2 are different in the direction along the optical axis of the light L. This is because the reflective optical element 214 is a deformed hexagon and the distances to the central axis 214C are different for each side surface.

As described above, the light path lengths of light L reflected by the third side surface 214c1 and the fourth side surface 214c2, which are located at different positions in the direction along the optical axis, are different from each other. That is, according to the optical scanning section 221 of the present embodiment, it is possible to make the light path lengths of the light beams incident on the same position of the light modulation section 122 different from each other. It should be noted that the amount of change in the light path length of the light incident on the same position of the light modulation section 122 can be adjusted by, for example, the degree of deformation or the size of the reflective optical element 214.

As described above, according to the image module 202 of the present embodiment, since the light path length of the light L incident on the same coordinates of the light modulation section 122 is changed to be equal to or longer than the coherence length, it is possible to superimpose the light beams having the light path length equal to or longer than the coherence length at the same position of the light modulation section 122. By this, according to the image module 202 of the present embodiment, it is possible to suppress speckle in the image light by suppressing the occurrence of interference fringes of the light L incident on each position of the light modulation section 122.

Therefore, according to the projector using the image module 202 of the present embodiment, since the image light in which speckle is suppressed is projected on the screen, it is possible to project a high-quality image in which speckle noise is suppressed.

It should be noted that in the image module 202 of the present embodiment, the optical scanning section 221 may scan the light modulation section 122 with two different color light beams. In this case, speckle noise of the two color light beams can be suppressed by generating a light path difference equal to or larger than the coherence length of the light beam that, among the two color light beams, has a long wavelength.

By combining three image modules 202 according to the present embodiment, the image modules may be applied to a three panel type projector as in the first embodiment.

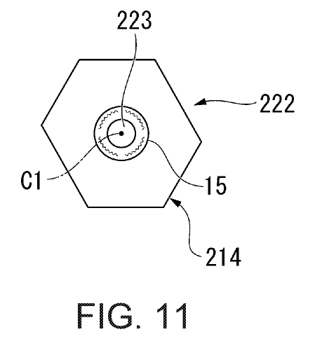

FIG. 11 is a diagram illustrating a configuration of an optical scanning section 222 according to a modification of the present embodiment.

The optical scanning section 222 illustrated in FIG. 11 includes a reflective optical element 214, the rotary drive device 15, and a vibration section 223. The vibration section 223 vibrates the reflective optical element 214 within a plane orthogonal to the rotation axis C1.

According to the optical scanning section 222 of the present modification, the vibration section 2233 vibrates the reflective optical element 214 in a plane orthogonal to the rotation axis C1, and thus it is possible to increase variations in the light path length of light reflected by each side surface of the reflective optical element 214 and incident on the same position of the light modulation section 122. By this, it is possible to more effectively suppress the occurrence of interference fringes of light incident on each position of the light modulation section 122, and to further reduce speckle in image light. Therefore, according to the projector using the image forming module including the optical scanning section 222 of the present modification example, it is possible to further improve the image quality of the projection image by further reducing speckle noise.

The technical scope of the present disclosure is not limited to the above-described embodiments, and various modifications can be made without departing from the spirit of the present disclosure.

For example, although the optical module that scans the three color light beams on the single liquid crystal panel 23 has been described as an example of the image module 2 of the first embodiment, the present disclosure may be applied to an image module that scans a single color light beam on a single liquid crystal panel. In a case where a single liquid crystal panel is scanned with monochromatic light, the light scanning section may be configured to change the light path length of scanned light incident on the same position of the liquid crystal panel to be equal to or longer than the coherence length of the monochromatic light. It should be noted that in the case where a single liquid crystal panel is scanned with monochromatic light, a general liquid crystal panel that does not include the first microlens array 43 or the second microlens array 44 can be used. A three panel type projector may be configured by combining three image modules corresponding to the respective colors of RGB.

In addition, the specific description of the shape, the number, the arrangement, the material, and the like of each component of the optical module and the projector is not limited to the embodiment described above, and can be changed as appropriate.

Hereinafter, an outline of the present disclosure is appended.

Appendix 1

An optical module includes

a light source including a first light emitting section configured to emit first light having a first wavelength;

a light scanning section that scans light emitted from the light source; and

a light modulation section that, based on image information, modulates scanned light scanned by the light scanning section, wherein

the light scanning section uses an optical element that rotates around a rotation axis extending along a direction intersecting an incident direction of the light to change a light path length of the scanned light incident on a same position of the light modulation section to be equal to or longer than a coherence length of the first light.

According to the optical module having this configuration, since the change amount of the light path length of the scanned light scanned on the light modulation section by the light scanning section is changed to be equal to or greater than the coherence length of the light incident on the transmissive optical element, it is possible to suppress the occurrence of interference fringes of the scanned light scanning on the light modulation section. By this, it is possible to suppress speckle in the image light generated by the optical module.

Appendix 2

The optical element is a transmissive optical element having an incident surface on which light from the light source is incident and an emitting surface from which the light incident from the incident surface is emitted,

the transmissive optical element has 2×m number of side surfaces, m being a natural number of 2 or more, the 2×m number of side surfaces intersecting a surface orthogonal to the rotation axis and connecting to the surface,

the 2×m number of side surfaces include two first side surfaces parallel to each other and two second side surfaces parallel to each other,

a dimension of the first side surfaces within a plane orthogonal to the rotation axis is different from a dimension of the second side surfaces within a plane orthogonal to the rotation axis, and

the incident surface and the emitting surface are at least either the two first side surfaces or the two second side surfaces amongst the 2×m number of side surfaces.

According to this configuration, the cross-sectional shape of the transmissive optical element along a plane orthogonal to the rotation axis can be a deformed form of a positive polygon. By this, the rotation state of the transmissive optical element when the light enters the predetermined position of the light modulation section via the first side surface and the rotation state of the transmissive optical element when the light enters the predetermined position of the light modulation section via the second side surface can be made different from each other. When the rotational state of the transmissive optical element is different, the incident angle with respect to the side surface of the transmissive optical element is different, and a difference occurs in the light path length path length of the light passing through the inside of the transmissive optical element. Therefore, according to the transmissive optical element having this shape, the light path length of the light incident on the same position of the light modulation section can be changed to be equal to or longer than the coherence length.

Since each of the first side surface and the second side surface is parallel to the side surface opposite to the side surface and there is no side surface that is not parallel, the generation of stray light in the transmissive optical element is small, and the light utilization efficiency can be increased.

Appendix 3

The light scanning section further includes a rotary drive device that rotates the optical element and a rotation fixing section that rotatably fixes the optical element to the rotary drive device,

the optical element is a reflective optical element that reflects light from the light source, and

a central axis that passes through a center of the reflective optical element is deviated from a rotation axis that passes through a center of the rotation fixing section.

According to this configuration, by making the reflective optical element eccentric with respect to the rotation axis, the position of the side surface that reflects the light incident on the same coordinate of the light modulation section can be made different in the direction along the optical axis of the light. By this, the light path length of the light incident on the same coordinate of the light modulation section can be changed to be equal to or longer than the coherence length.

Appendix 4

The rotation fixing section has a notch formed on an opposite side of the rotation axis with respect to the central axis on a virtual line connecting the central axis and the rotation axis.

According to this configuration, the combined center of gravity of the rotation fixing section and the reflective optical element 4 approaches the rotation axis, and thus it is possible to suppress the occurrence of vibration and noise due to surface wobble when the rotation fixing section and the reflective optical element rotate around the rotation axis.

Appendix 5

The optical element is a reflective optical element that reflects light from the light source,

the reflective optical element has a plurality of side surfaces that intersect a surface orthogonal to the rotation axis and that connect with the surface,

the plurality of side surfaces includes two third side surfaces parallel to each other and two fourth side surfaces parallel to each other, and

a dimension of the third side surfaces within a plane orthogonal to the rotation axis is different from a dimension of the fourth side surfaces within a plane orthogonal to the rotation axis.

According to this configuration, the position in the direction along the optical axis of the light on the third side surface when the light is reflected by the third side surface and incident on the predetermined position of the light modulation section and the position in the direction along the optical axis of the light on the fourth side surface when the light is reflected by the fourth side surface and incident on the predetermined position of the light modulation section can be made different from each other. Therefore, according to the reflective optical element having this shape, the light path length of the light incident on the same position of the light modulation section can be changed to be equal to or longer than the coherence length.

Appendix 6

The light scanning section includes a vibration section that vibrates the reflective optical element in a plane orthogonal to the rotation axis.

According to this configuration, it is possible to increase the variation of the light path length of the light reflected by each side surface of the reflective optical element and incident on the same position of the light modulation section. By this, it is possible to further reduce speckle of the image light generated by the light modulation section.

Appendix 7

The light source further includes a second light emitting section that emits second light having a second wavelength longer than the first wavelength and

the amount of change in the light path length of the scanned light is equal to or greater than the coherence length of the second light.

According to this configuration, by generating the light path difference equal to or larger than the coherence length of the second light having a long wavelength, it is possible to set a state in which the light path difference equal to or larger than the coherence length is also provided to the first light. Therefore, it is possible to suppress speckle noise of both the first light and the second light.

Appendix 8

A projector includes

the optical module and the optical module according to any one of Appendixes 1 to 7, and

the projection optical device projecting the light emitted from the optical module.

According to the projector having this configuration, since the image light in which speckle is suppressed is generated by the optical module, it is possible to project a high-quality image in which speckle noise is suppressed.

What is claimed is:

1. An optical module comprising:
a light source including a first light emitting section configured to emit first light having a first wavelength; a light scanning section that scans light emitted from the light source; and
a light modulation section that, based on image information, modulates scanned light scanned by the light scanning section, wherein
the light scanning section uses an optical element that rotates around a rotation axis extending along a direction intersecting an incident direction of the light to change a light path length of the scanned light incident on a same position of the light modulation section to be equal to or longer than a coherence length of the first light.

2. The optical module according to claim 1, wherein
the optical element is a transmissive optical element having an incident surface on which light from the light source is incident and an emitting surface from which the light incident from the incident surface is emitted,
the transmissive optical element has 2×m number of side surfaces, m being a natural number of 2 or more, the 2×m number of side surfaces intersecting a surface orthogonal to the rotation axis and connecting to the surface,
the 2×m number of side surfaces include two first side surfaces parallel to each other and two second side surfaces parallel to each other,
a dimension of the first side surfaces within a plane orthogonal to the rotation axis is different from a dimension of the second side surfaces within a plane orthogonal to the rotation axis, and
the incident surface and the emitting surface are at least either the two first side surfaces or the two second side surfaces amongst the 2×m number of side surfaces.

3. The optical module according to claim 1, wherein
the light scanning section further includes a rotary drive device that rotates the optical element and a rotation fixing section that rotatably fixes the optical element to the rotary drive device,
the optical element is a reflective optical element that reflects light from the light source, and
a central axis that passes through a center of the reflective optical element is deviated from a rotation axis that passes through a center of the rotation fixing section.

4. The optical module according to claim 3, wherein
the rotation fixing section has a notch formed on an opposite side of the rotation axis with respect to the central axis on a virtual line connecting the central axis and the rotation axis.

5. The optical module according to claim 1, wherein
the optical element is a reflective optical element that reflects light from the light source,
the reflective optical element has a plurality of side surfaces that intersect a surface orthogonal to the rotation axis and that connect with the surface,
the plurality of side surfaces includes two third side surfaces parallel to each other and two fourth side surfaces parallel to each other, and
a dimension of the third side surfaces within a plane orthogonal to the rotation axis is different from a dimension of the fourth side surfaces within a plane orthogonal to the rotation axis.

6. The optical module according to claim 5, wherein
the light scanning section includes a vibration section that vibrates the reflective optical element in a plane orthogonal to the rotation axis.

7. The optical module according to claim 1, wherein
the light source further includes a second light emitting section that emits second light having a second wavelength longer than the first wavelength and
the amount of change in the light path length of the scanned light is equal to or greater than the coherence length of the second light.

8. A projector comprising:
the optical module according to claim 1 and
the projection optical device projecting the light emitted from the optical module.
